(19) United States
(12) Patent Application Publication
(10) Pub. No.: US 2025/0165447 A1
(43) Pub. Date: May 22, 2025

(54) SYSTEM AND METHOD FOR EFFICIENTLY IMPORTING GEOSPATIAL DATA INTO THE H3 INDEXING SYSTEM

(71) Applicant: Southern Oregon University, Ashland, OR (US)

(72) Inventor: Kevin Sahr, Applegate, OR (US)

(73) Assignee: Southern Oregon University, Ashland, OR (US)

(21) Appl. No.: 18/949,779

(22) Filed: Nov. 15, 2024

Related U.S. Application Data
(60) Provisional application No. 63/599,925, filed on Nov. 16, 2023.

(51) Int. Cl. G06F 16/22; G06F 16/29

(52) U.S. Cl. CPC G06F 16/2246; G06F 16/29

(57) ABSTRACT

Determination of addresses in hierarchical grid systems is based on precomputed values used to define skip tables that are applied to permit determination of indices of cells at coarser resolutions than a target cell, without direct computations. The skip tables can be defined to permit skipping direct determination of indices of cells at one or more of the coarser resolutions using integer arithmetic thereby improving computation speeds required for navigation and other applications. Application of skip tables to a target cell at an entry resolution produces indices for cells at one or more skipped over, coarser resolutions and coordinates for a cell at a next coarser resolution. These coordinates can be used to re-apply the skip table so that a complete address associated with a target cell can be found. Target location can be similarly obtained using an inverse skip table.

### CROSS REFERENCE TO RELATED APPLICATION

This application claims the benefit of U.S. Provisional Application 63/599,925, filed Nov. 16, 2023, entitled “System and Method for Efficiently Importing Geospatial Data into the H3 Indexing System,” which is incorporated herein by reference.

### FIELD

The disclosure pertains to indexing in global grid systems.

### BACKGROUND

The H3 hexagonal hierarchical geospatial indexing system is widely used in geospatial artificial intelligence and machine learning applications, as well as other types of geospatial analysis, visualization, and operations support, and has been proposed for a wide variety of other geospatial applications, including autonomous vehicles. Before geospatial data can be manipulated in the H3 system it must first be imported by converting the data locations from a geographic latitude/longitude coordinate system to H3 hierarchical addresses. This step is a critical chokepoint in the data processing pipeline, especially for extreme high data volume and/or high velocity/real-time applications. Conventional methods for obtaining these addresses tend to be computationally intensive and slow and are thus inadequate for many applications. Improved approaches are needed.

### SUMMARY

Disclosed herein are methods and apparatus that can provide efficient performance of conversion operations needed in H3 and other grid systems to obtain a hierarchical address for a target location at multiple resolutions. In one example, a latitude/longitude point is mapped to a corresponding cell at a particular resolution in a grid system and then processed with a skip table to produce indices of associated cells at a plurality of resolutions, thereby avoiding more complex and time consuming calculations required by conventional approaches which require individual computations for each resolution.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1A illustrates a portion of an aperture 7 hexagonal grid.

FIG. 1B illustrates an enlarged portion of the aperture 7 hexagonal grid of FIG. 1A.

FIG. 1C illustrates the aperture 7 hexagonal grid of FIG. 1A with cell coordinates indicated in the fine resolution cells and without showing an intermediate resolution for which skip table processing can obtain a suitable index.

FIG. 1D illustrates the enlarged portion of the aperture 7 hexagonal grid of FIG. 1C with cell coordinates indicated in the fine resolution cells.

FIG. 1E illustrates the enlarged portion of the aperture 7 hexagonal grid of FIG. 1D with cell coordinates indicated in the fine resolution cells and without the intermediate resolution grid.

FIG. 1F illustrates an alternative hierarchical grid system.

FIG. 2A illustrates a representative method of using a skip table to find indices in a hierarchical grid system.

FIG. 2B illustrates representative indices found using the method of FIG. 2A.

FIG. 3A illustrates a quadrant skip table sector.

FIG. 3B illustrates a representative complete skip table sector.

FIG. 4 illustrates a representative method of obtaining cell indices using a skip table for a complete skip table sector.

FIGS. 5A-5B illustrate a target cell as placed with respect to a complete skip table sector.

FIG. 5C illustrates a skip table associated with the complete skip table sector of FIGS. 5A-5B.

FIG. 5CC illustrates skip table entries of the skip table of FIG. 5C mapped to cells of a fine grid.

FIG. 5D illustrates an auxiliary skip table used to find coordinates of a cell at a skip table exit resolution.

FIG. 5E illustrates representative indices.

FIG. 5F illustrates a representative assignment of indices to a coarse grid at a skip table exit resolution.

FIG. 6 illustrates a representative method of obtaining cell indices using a skip table.

FIG. 7 illustrates a representative processing device for performing any of the disclosed methods.

FIG. 8 illustrates a representative navigation system that includes skip table processing.

FIG. 9 illustrates a representative method of processing a set of grid indices to obtain spatial coordinates of a target location or cell coordinates of a finest resolution cell using skip table processing with an inverse skip table.

FIG. 10 illustrates a representative logistics management system.

### DETAILED DESCRIPTION

The disclosure pertains generally to computer-based manipulation of data associated with hierarchical grid systems of pure or mixed aperture hexagons as mapped or mappable to a sphere, torus, plane, polyhedron, or other surfaces. In such grid systems, a hierarchy of cells of different resolutions ranging from a coarsest resolution (largest cell) to a finest resolution (smallest cell) is defined in which cell area changes from level to level by a factor referred to herein as an aperture. In some examples in which a grid system is mapped to a sphere, latitude and longitude are used to identify a target cell at a selected resolution and the approaches below permit processor-efficient and rapid determination of associated cells at other, coarser resolutions. Alternatively, a cell index can be processed to determine an associated location. Conventional approaches for such determinations can be computational slow or require particular processing hardware, both of which make implementation for typical user applications difficult.

Disclosed herein are methods and apparatus that provide cell indices for hierarchical grid systems using sets of predetermined values that can be stored in a memory device as a look-up table. Such cell indices correspond to the hierarchical addresses required for applications such as route or location finding. The sets of predetermined values used to determine cell indices are referred to as “skip tables” herein. Skip tables provide an innovative data structure as well as providing substantial improvement in processing time needed to calculate cell indices. Rapid determination of cell indices is of particular importance in the use of grid systems in applications such as position location and route finding. Skip tables permit indices cells at some resolutions to be obtained without computationally intensive processing by “skipping” over direct computation at these resolutions.

Sequences of grids (referred to herein as “hierarchical grids”) that include arrays of finer and coarser grids can be described based on one or more elements that are repeated to form the grid (for example, hexagons, pentagons, or combinations thereof) and areas of the next finer grid elements. For example, for grids formed of hexagons, finer grids can be defined from a grid of initial or “parent” hexagons based on “child” hexagons having areas of ⅓, ¼, and 1/7 of the area of a parent hexagon. Some such finer grids are referred to as aperture 3 (A3), aperture 4 (A4), and aperture 7 (A7), respectively, based on area scaling. In other examples, some finer grids are based on scaling of linear dimension ratios by factors such as √7, √4, √3 corresponding to apertures A7, A4, A3, respectively. In the disclosed examples, grids are described with respect to regular or irregular polygons such as hexagons, pentagons, triangles or other regular or irregular shapes. For convenience, such grid elements are also referred to as cells, and if generated based on a larger or smaller cell, can be referred to as a “child” cell or a “parent” cell, respectively. Grid systems can be established using a single scale factor (i.e., single aperture referred to as “pure aperture”) of multiple scale factors (i.e., multiple scale factors referred to as “mixed aperture”).

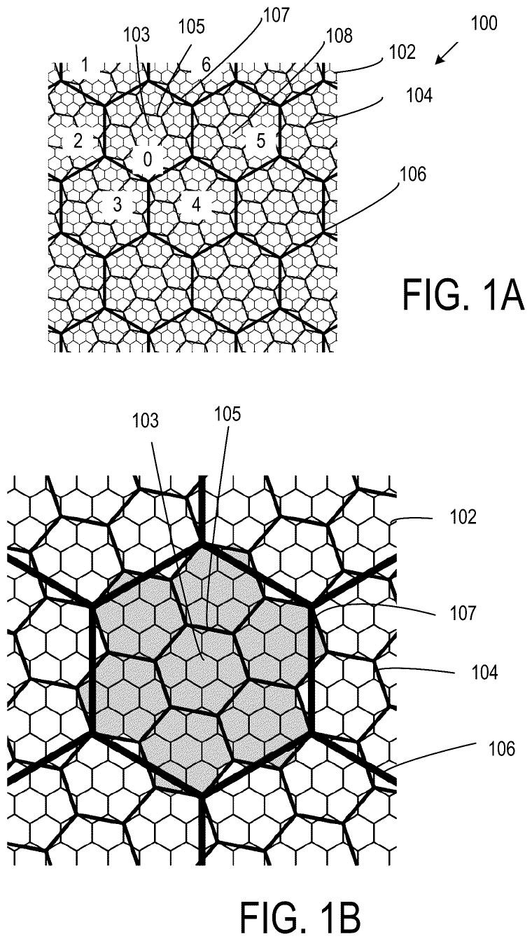

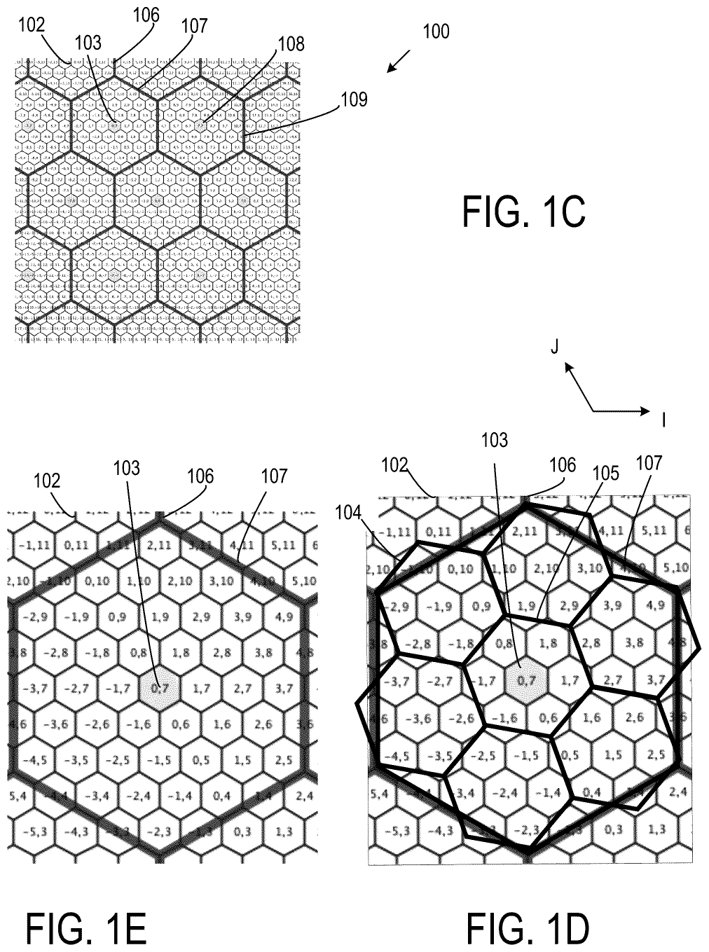

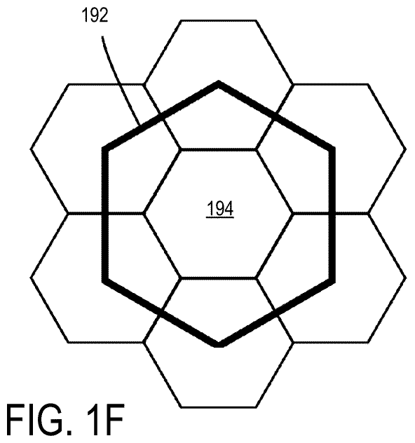

Indexing is described briefly herein for convenient explanation and is described in detail in, for example, U.S. Pat. No. 9,311,350, which is incorporated herein by reference. Cells in a multi-resolution pure or mixed aperture grid are indexed (i.e., assigned an address) that can be stored. In a representative indexing method, starting with a coarsest resolution of cells (referred to in this example as resolution 0 cells or base cells), each base cell is assigned a unique address, such as an integer 1, 2, 3, 4, etc. For example, in FIGS. 1A-1C, coarsest hexagons such as hexagon 107 in grid 106 can be base cells and each of the base cells can be assigned a unique integer address (0), (1), (2), (3), etc. These base cell addresses can be arranged in any convenient pattern. For example, in FIG. 1A, the hexagon 107 can be addressed as (0) and the six neighboring hexagons of the same size can be addressed as (2) through (6). Next, for each base cell, an index consisting of the index of the address of the parent base cell with one of the digits 0-6 appended is assigned to its concentric child cell and to each of its other six child cells (i.e., resolution 1 cells). For example, in FIG. 1A, for the base hexagon 107, which was given an address of (0), a concentric child hexagon 105 in a grid 104 is assigned an index of (0,0) and the six vertex child hexagons are assigned indices (1,1) through (1,6). Likewise, for a base hexagon adjacent to the hexagon 107 assigned an address of (4), the seven child hexagons are assigned addresses (4,0) through (4,6).

Similarly, for each resolution 1 cell, an index consisting of the index of the address of the parent base cell with one of the digits 0-6 appended is assign to its concentric child cell and to each of its other six child cells (i.e., resolution 2 cells). For example, in FIG. 1A, for the resolution 1 hexagon 105, which was given an address of (0,0), its concentric child cell 103 is assigned an index of (0,0,0) its six vertex child cells are assigned indexes of (0,0,1) through (0,0,6). Likewise, for the resolution 1 hexagon which is assigned an address (0,6), its seven children are assigned addresses (0,6,0) through (0,6,6). In general, given a resolution k cell P, the resolution k+1 cell P′ centered on P and each of the resolution k+1 neighbors of P′ can be assigned an index consisting of the index of P with one of the digits 0-6 appended.

The grid arrangement of FIGS. 1A-1C is one example of an aperture 7 hierarchical grid. FIG. 1F illustrates an alternative arrangement in which coarsest resolution cells such as cell 194 are rotated 90 degrees with respect to a finer resolution cell 192, and other finer and coarser grids have orientations that alternate in the same way. There are other suitable arrangements of single aperture grids of other grids and mixed aperture grids as described in U.S. Pat. Nos. 7,876,967 and 8,229,237 that are both incorporated herein by reference.

For a given grid geometry, cell indices (referred to in some cases as location codes or addresses) are assigned to the cells and stored using any suitable coding form. Some examples include the following: a character string code form; an integer code form; a modified integer code form; and a packed code form. Coding is more fully discussed in patent documents incorporated by reference above. Using grids and cell indices, assignment of data to various locations as well as determinations of distances and paths between locations can be more efficiently implemented using dedicated or less complex processors as only integer calculations are required. This can simplify design, increase battery life in mobile navigation systems, and permit more rapid determinations. In many practical examples, this data is geographical data, and the disclosed approaches address problems in processor-based access, storage, and manipulation of such data. Representative applications include satellite imagery, average temperatures or other weather or climate-related quantities, land cover classifications, soil classifications, microclimates, terroirs, or other geographical or geological, plant/animal populations, demographics, or other quantities which are associated with areas or can be mapped to be associated with areas, navigation systems, ride-hailing systems, and autonomous vehicles. Still other applications include image processing and analysis, pattern recognition, path planning, and other applications. Cells can also represent point (or “vector”) locations. Other representative examples include navigation systems, ride-hailing systems, and autonomous vehicles or drones.

### Example Embedding and Grid

As an example for use in explanation, a hexagonal grid of aperture 7 can be defined as a series of hexagonal grids of increasing resolution, i.e., having hexagonal cells of decreasing size. For purposes of illustration, only selected grids of such a series are discussed in the example below although in typical applications, many such grids are needed.

As discussed above, FIGS. 1A-1B illustrate a set 100 of three aperture 7 hexagonal grids in a sequence of aperture 7 Class II hexagonal grids from a fine resolution grid to a coarse resolution, referred to herein as a fine grid 102 that includes fine cells such as the representative cell 103 an intermediate grid 104 that includes intermediate cells such as the representative cell 105, and a coarse grid 106 that includes coarse cells such as the representative cell 107. The set 100 includes only three grid resolutions more still finer and/or still coarser cells can be provided. In the arrangement of FIG. 1C, fine cells such as the cell 103 and coarse cells such as the cell 107 are similarly oriented or aligned so that cell edges are parallel.

FIG. 1B illustrates the cell 107 as a center of the coarse grid 106 with coordinates indicated for each of the cells of the fine grid 102. In the set 100 as shown in FIGS. 1A-1B, the cells of the fine grid 102 have areas that are 1/49 the area of cells in the coarse grid 106. The fine grid 102 and the coarse grid 106 are particular grids of an aperture 7 sequence in which an intermediate grid 104 of intermediate cells such as intermediate cell 105 is shown in FIG. 1C. The intermediate cells have areas that are 1/7 the area of the coarse cells and the fine cells have areas that are 1/7 of the areas of the intermediate cells as this is an aperture 7 grid. As shown in FIGS. 1A-1C, the fine cells and coarse cells are hexagons having hexagon edges that are parallel while the intermediate cells are hexagons that are tilted with respect to the fine cells and the coarse cells. In this type of grid arrangement, any two grids that omit a single intermediate grid comprise aligned hexagons. As shown in FIG. 1A, centers of cells in the coarser grid (such as representative coarser cell 109) correspond to cells in a finer grid whose I,J coordinate address has i and j components that are evenly divisible by 7, which we will refer to as “center cells,” such as representative finer cell 108. Index computations can be streamlined for aligned grids using skip tables as discussed below.

### Introduction to Skip Table Processing

For hierarchical grids, methods and apparatus are described that provide cell indices using sets of predetermined values that can be stored in a memory device as a look-up table. These sets of predetermined values are referred to as “skip tables” herein. Skip tables define an innovative data structure and provide substantial improvement in processing time needed to calculate cell indices. Skip tables can also be provided to process cell indices to cell coordinates and location such as latitude and longitude. Rapid processing of cell indices is of particular importance in the use of grid systems in applications such as position location and route finding. Skip tables permit indices of cells at at least some resolutions and locations associated with cell indices to be obtained without computationally intensive processing.

Referring again to FIGS. 1A-1D, global grid system that includes the set 100 of cells can be extended to cover a spherical or other surface as needed. The grid system is shown with the representative cells 103, 105, 107 having areas that differ by factors of 7 corresponding to three resolutions in an aperture 7 system. The cell 103 and the cell 107 are elements of the respective grids 102, 106 (a finer and a coarser resolution, respectively) having a common alignment while cells of intermediate resolution in the grid 105 have a different orientation. FIG. 1A illustrates the cells 103, 105, 107 in detail; in FIG. 1C, the finer resolution and coarser resolution grids 102, 106, and the associated cells 103, 107 are shown and the intermediate resolution grid 104 and the associated cell 105 are omitted. As discussed in detail below, a skip table can be defined and applied to the determination of cell indices for a cell at the resolution of the grid 102 and the associated cell at the intermediate resolution in the grid 104 by “skipping” a direct calculation of the index of the cell in the grid 104. To illustrate this skipping, cells of the intermediate resolution grid 104 are not shown in FIGS. 1C and 1E. In addition, application of a skip table to a cell in the grid 102 provides coordinates or other parameters that identify an associated cell in the coarser resolution grid 106 so that the skipping procedure can be re-applied to obtain cell indices at all resolutions or all resolutions of interest.

The grid system of FIGS. 1A-1D is provided as an example. In any grid system having grids with different orientations at different grid resolutions, skip tables can be defined that permit determination of cell indices at multiple resolutions rapidly, with efficient integer arithmetic which speeds execution using logical processing devices. In skip table-based processing, entry and exit cell orientations need not be the same but it may be convenient. The examples below generally pertain to skip tables associated with common entry and exit cell orientations for purposes of illustration.

### Terminology Associated with Skip Table Processing

Cell locations are identified with coordinates (I,J) along coordinate axes, wherein I, J are integers. Cell indices are used to identify particular cells associated with a target cell at multiple coarser resolutions. Coordinate axis directions can depend on the grid used. In the examples provided below (an aperture 7 hierarchy) for explanation, an I-axis is shown as horizontal, and a J-axis is at an angle of 120 degrees with respect to the I-axis. Skip table processing is used to find indices of cells at one or more coarser resolutions from an initial resolution to produce a location index X0, X1, . . . , XN, wherein X0 and XN denote the associated cells at the coarsest and finest resolutions of a grid, respectively. Skip tables are associated with finding indices of cells at a finest resolution and a coarsest resolution, wherein the finest and coarsest resolutions are associated with cells having a common orientation. As used herein, “skip table orientation” refers to this common cell orientation. Skip tables are referred to herein based on a number of grid resolutions that are provided indices by application of the skip table. An M-level skip table applied to a cell of resolution N provides grid indices for M cells at respective grid resolutions N, N−1, . . . N−M+1. An M-level skip table is defined by determining and storing grid indices of substantially all and in most cases, all, cells of a skip table sector that contains at least A² cells, wherein A is a grid aperture. For mixed aperture systems, a minimum number of cells for a skip table is based on a product of the apertures A, A′. In the examples discussed herein, an M-level skip table can be used to find indices of cells having resolution M cells at grid resolutions N, N−1, . . . N−M+1, wherein N is a table entry resolution, i.e., a finest resolution input for skip table processing. Skip table entry and exit resolutions (N and N−M, respectively) are associated with cells having the skip table orientation. While some examples are described in which N is a finest resolution of cells at a particular orientation, N can denote any resolution having the skip table orientation. Two-level skip tables are conveniently based on skip table sectors that include A by A or 2A by 2A cells and have an (I=0, J=0) cell as a skip table section corner or center. Skip tables of 2A-by-2A cells using negative numbers for some (I,J) and a (0,0) coordinates for a central cell tend to be convenient. Skip sectors for larger numbers of skipped levels will be larger.

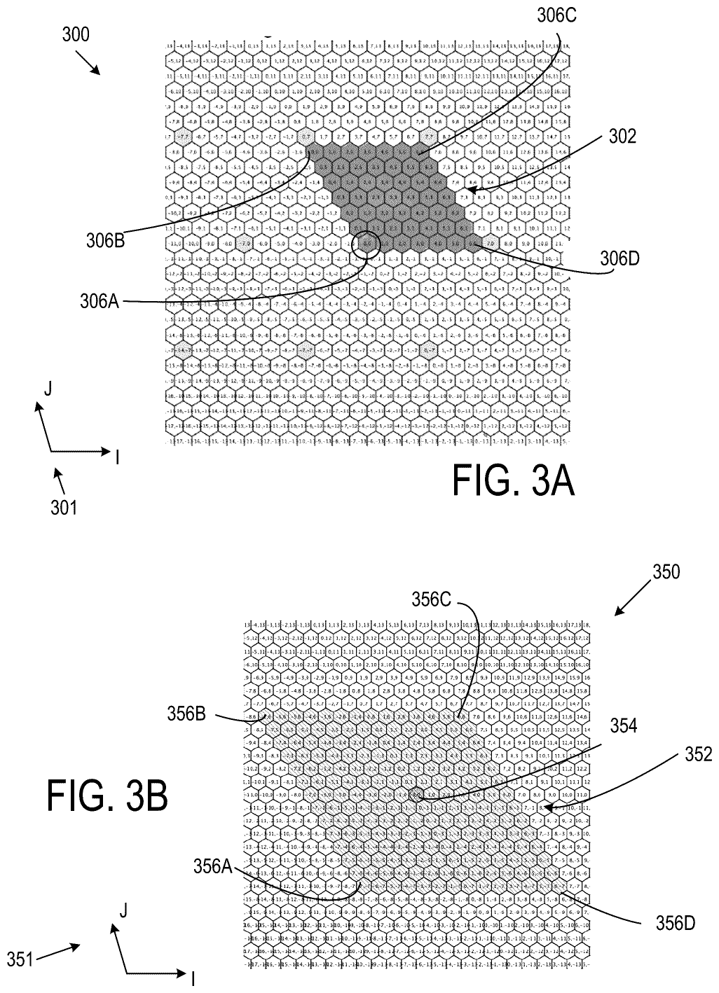

A subset region of cells designated a “skip table sector” is mapped to entries in a skip table. Multiple methods exist for determining an appropriate skip table sector and associated skip table. FIG. 3A illustrates an example skip table sector determined using a quadrant sector approach. In the quadrant sector approach the origin of the sector is the lower left cell in the sector, and the maximum I and J dimensions of the sector are determined based on the number and aperture(s) of skipped resolutions.

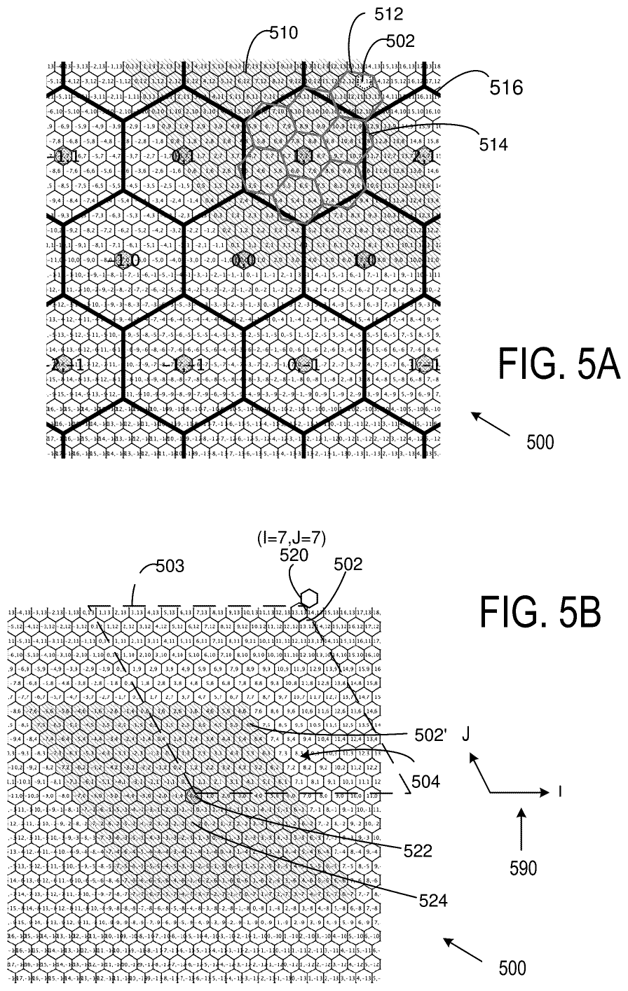

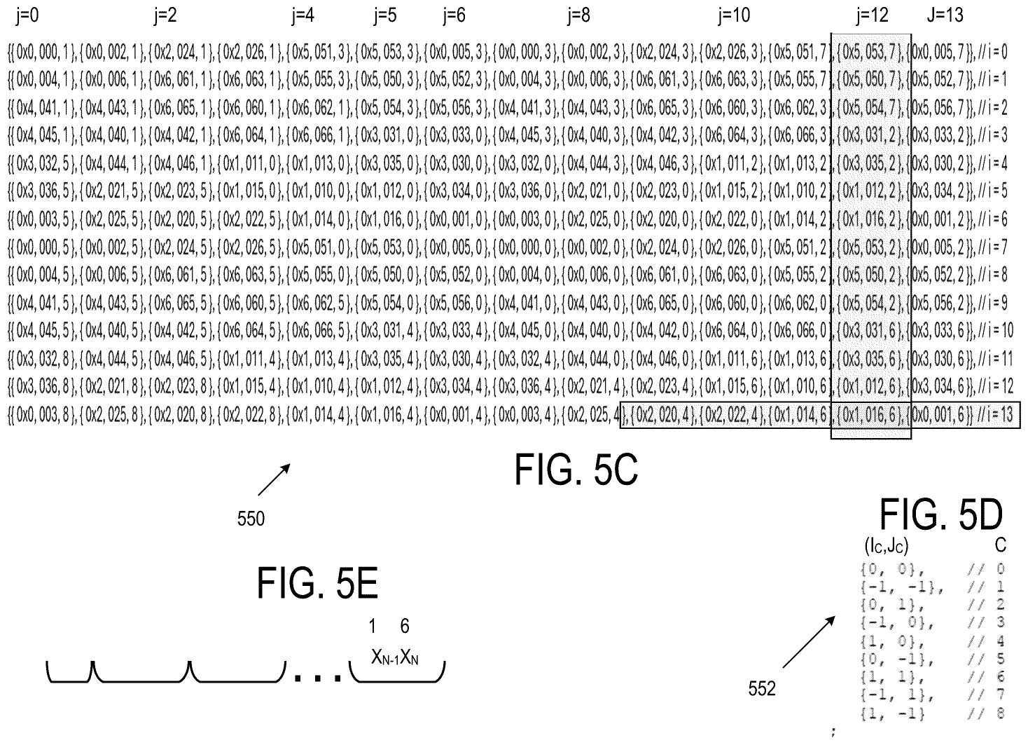

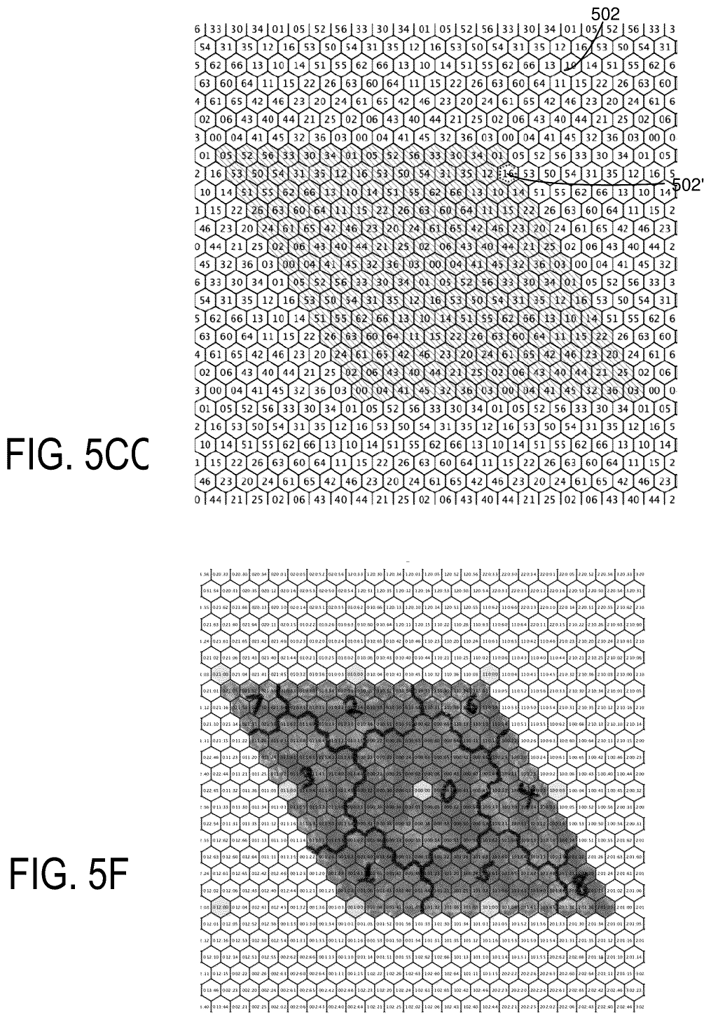

FIGS. 5A-5B illustrate an example skip table sector determined using a complete sector approach. In this approach, the origin of the skip table sector is the middle cell in the skip table sector. The number of cells in the I and J dimensions of the skip table sector are typically twice the size of the dimensions for a corresponding quadrant sector.

The examples discussed in detail are based on a 2-level skip table for a grid system in which cell orientation alternates between first and second orientations. For such a grid system, any even value of M can be used to define a suitable skip table. In other grid systems, cell orientations change from first, second, third or more orientations and in general, an M-level skip table can be provided for any positive integer M. If a grid system has first, second, and third cell orientations, then skip tables for any integer multiple of three can be provided. However, in general, skip tables can be impractically large for large values of M, such as M greater than 5.

By applying an M-level skip table to initial cell coordinates (I,J) of a resolution N cell (sometimes referred to herein as a “target cell”), cell indices X_{N}, X_{N-1}, . . . , X_{N-M+}1 for cells of resolution N, N−1, . . . N−M+1 are obtained along with updated initial cell coordinates (I′,J′) of the associated N-M resolution cell, i.e., coordinates of an associated cell at a next coarser resolution (in some cases, referred to as a cell at a skip table exit resolution). These updated initial cell coordinates (I′,J′) can be processed using the M-level skip table in the same manner to produce cell indices X_{N-M}, X_{N-M-}1, . . . X_{N-2M+1} for cells of resolution N−M−1, N−M−2, . . . , N−2M+1 and updated initial coordinates (I′,J′) of a resolution N−2M cell which can in turn be processed using the skip table. The process can be repeated as needed to obtain some or all cell indices.

Skip tables are defined to provide indices for cells at an initial (finer) resolution and one or more intermediate resolutions and coordinates (I,J) for a final (coarser) resolution, wherein the cells of the initial (finer) resolution have the same shape and alignment as cells of the final (coarser) resolution, wherein both initial and final resolutions are associated with cells at a skip table orientation. The initial and final resolutions are referred to herein as a skip table entry resolution (or entry resolution) and a skip table exit resolution (or exit resolution). These table entry resolutions are associated with table entry and table exit orientations (the skip table orientation). However, choice of specific grid resolutions is not needed as table entry and table exit resolutions are applicable to cells of any resolution having the skip table orientation and a number of intermediate resolutions associated with a particular skip table. For example, for 2-level skip table established for a particular skip table orientation of the grid 102 of FIGS. 1A-1C, the skip table can be applied to grids in the same orientation at any resolution. If the skip table is associated with a table entry cell orientation at resolution N, the same skip table is suitable for table entry at resolutions N−2, N−4, N−6, For hierarchical grid systems in which cells have the same shape and alternate orientations from level-to-level, skip tables for M=2, 4, 6, 8 . . . can be provided. Skip tables for larger values of M may be bigger than desired and smaller values of M are generally used. For hierarchical grid systems in which cells have alternate orientations from level-to-level, skip tables can be provided for each of the two cell orientations so that skip table processing can be applied to any target cell without an initial step of finding a cell index at a coarser resolution that corresponds to a skip table orientation associated with a particular skip table. The examples below are described in detail for an M=2 skip table in a hierarchical grid system with alternating cell orientations for convenient explanation. Skip tables for different values of M can also be used, and processing of any target cell be accomplished with multiple skip tables.

Because a skip table is suited for index determinations between grids having similarly oriented cells at any resolution, a skip table entry resolution refers to any resolution having cells oriented as specified by the skip table; a skip table exit resolution of an M-level skip table is a resolution that is M levels coarser that a resolution associated with the skip table entry resolution. In some cases, target cells have orientations that do not conform to a skip table orientation and are processed to find one or more cells indices of coarser cells to produce a coarser cell at a skip table orientation which is suitable for skip table processing. Similarly, a skip table exit resolution can correspond to an orientation for which still coarser cells and the associated indices can be obtained without the skip table.

As used herein, a hierarchical grid address (or address) is a sequence of indices identifying a series of cells in the hierarchical grid of different resolutions corresponding to a target cell. The term “index” generally refers to an identifier of a cell as a particular resolution, but in some case, index or indices is used to refer to a series of individual cell indices corresponding to an address.

### Example 1. Representative Method of Skip Table Processing

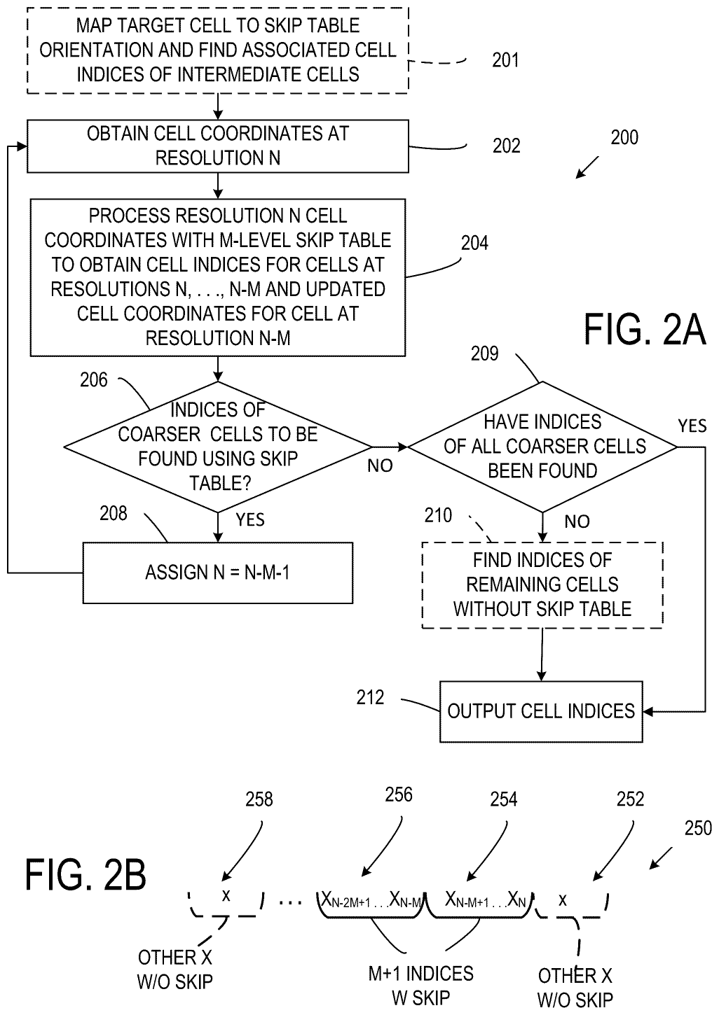

Referring to FIG. 2A, a representative method 200 includes obtaining cell coordinates of an initial cell or “target” cell at a resolution N at 202. The target cell typically is a resolution N cell at a location determined by latitude and longitude of a selected location of interest. In some cases, the target cell is mapped to a skip table orientation at 201 so that a reorientated target cell at a coarser resolution is available for skip table processing. At 204, the target cell at resolution N is processed with an M-level skip table to obtain indices of cells at resolutions N, N−1, . . . N−M+1 and updated cell coordinates for an associated cell at resolution N−M. For example, for a 2-level skip table, indices for cells at resolutions N, N−1 are obtained along with cell coordinates for an associated cell at resolution N−M.

At 206, it is determined if additional cells at still coarser resolutions are to be found using the skip table. In some cases, a single application of a skip table provides indices down to a coarsest desired or available resolution. In some cases, there are no additional resolutions to be skipped with the skip table (for example, fewer than M resolutions remain to reach a coarsest resolution) and a direct computation is used. For example, with a 2-level skip table, cells at resolution 1 are processed in other ways to obtain cell indices at resolution 0, the coarsest available resolution. Processing without a skip table is provided at 210 and cell indices for multiple resolutions are available at 212. If additional skip table processing is indicated at 206, cell resolution N is changed to N−M at 208 and the updated cell coordinates at resolution N−M are provided at 202 and the process is repeated.

FIG. 2B illustrates determining indices of a target cell down to an index of a coarsest level using an M-level skip table. Indices 252 (shown simply as X in FIG. 2B) are obtained without the skip table to provide coordinates of a cell at resolution N that corresponds to a cell orientation associated with the skip table, i.e. a table entry resolution. Application of the skip table to the cell at resolution N produces M indices X_{N}, . . . , X_{N-M+1} as shown at 254 and a subsequent application of the skip table produces indices X_{N-M}, . . . , X_{N-2M+1} as shown at 256. Additional indices are obtained by reapplication of the skip table. A final set of one or more indices as shown at 258 are obtained without the skip table. The indices 252, 258 are typically provided without the skip table in association with resolutions that are inconsistent with the skip table, such as different orientations than a skip table entry or exit orientation or a number of levels produced by the skip table is larger than desired or obtainable based on a number of skip levels in the skip table. In some cases, multiple skip tables are provided, and non-skip table processing can be avoided. For example, with grids shown in FIGS. 1A-1C, there are two cell orientations and skip tables can be produced for each and selected for application based on a target cell orientation and a final resolution.

### Representative Skip Table Sectors

Skip tables include precomputed values for providing cell indices for an input resolution and skipped over resolutions. Skip tables are based on sets of cells (referred to herein as “sectors”) that include sufficient cells to permit a skip table to be useful for an arbitrary input resolution cell. Additional sets of cells arranged in a similar fashion to the cells of a skip table section can be arranged to tile a surface associated with a hierarchical grid system such as a spherical or planar surface. For a hierarchical grid of aperture A, a minimum number of cells in a sector that defines an M-level skip table is A^{M}.

FIGS. 3A-3B illustrate representative skip table sectors 302, 352 that can be used to define skip tables for respective aperture 7 grid layouts 300, 350. In FIG. 3A, the skip table sector 302 is defined to have ((I,J) coordinates along coordinate axes 301 of (0,0) at cell 306A and extend to cells 306B, 306C, 306D having coordinates (0,6), (6,6), and (6,0), respectively. For an M-level skip table with M=2, indices for each of the cells in the skip table sector 302 and at an intermediate and coarser resolution such as the grid 104 of FIGS. 1B-1C can be stored and arranged as a skip table or part of a skip table. Coordinates of cells outside of the skip table sector 302 can be translated to the skip table sector 302 for application of the associated skip table.

In FIG. 3B, the skip table sector 352 is a 14 by 14 set of cells and is defined to have coordinates (0,0) at a central cell 354 and extends to cells 356A-356D having coordinates (−7,−7), (−7,6), (6,6), (6,−7), respectively. For an M-level skip table with M=2, indices for each of the cells in the skip table sector 352 and at an intermediate and coarser resolution such as the grid 104 of FIGS. 1A-1C) can be stored and arranged as a skip table or part of a skip table. Coordinates of cells outside of the skip table sector 352 can be translated to the skip table sector 352 for application of the associated skip table to find cell indices for M resolutions.

Other shapes and sizes of skip table sectors can be used and those shown in FIGS. 3A-3B are merely examples. The arrangement of FIG. 3B using 14 by 14 cells is convenient as the use of negative integers as cell coordinates tends to make computation simpler.

### Two-Level Skip Table Processing in an Aperture 7 Hierarchy

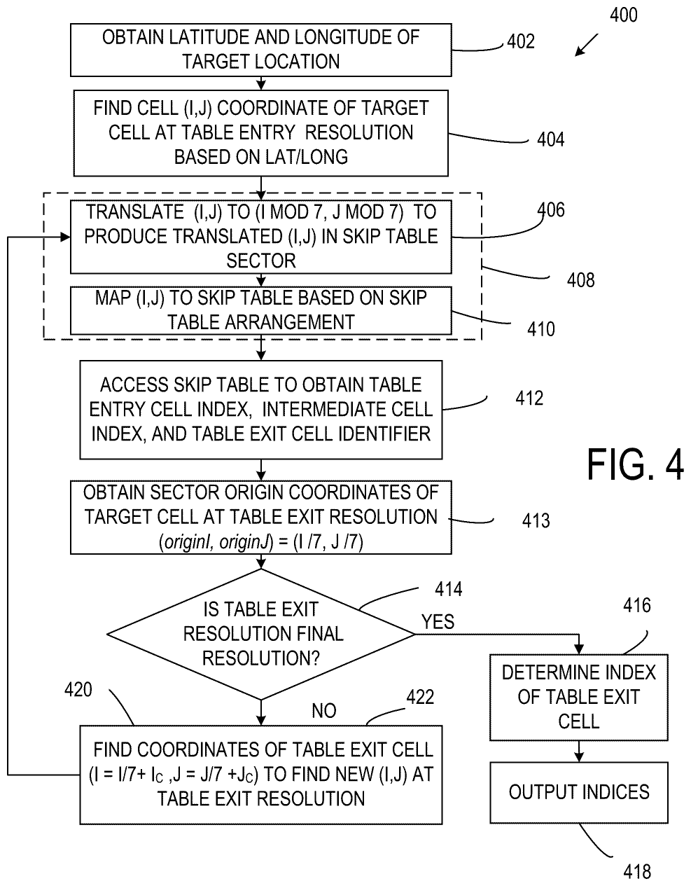

A representative method 400 illustrated in FIG. 4 for a two-level skip table (M=2) for an aperture 7 grid includes obtaining a latitude and longitude of a target location at 402. At 404, coordinates (I,J) associated with a target cell associated with the target location are obtained. In this example, the target cell is at a skip table resolution and processing to find a cell at a different resolution is not needed to prepare for use of a skip table. At 406, the coordinates (I,J) of the target cell are translated to a skip table sector to produce translated coordinates. At 410, the translated coordinates are mapped to the skip table as needed. The mapping at 410 depends on the arrangement of the skip table and in some case, is unnecessary. Skip tables are typically arranged for convenient processing using digital logic processors such as central processing units, application specific integrated circuits, gate arrays, or other logic device. The translation and mapping can be combined in a single operation as both generally require integer operations such as integer additions and subtractions as indicated generally at 408. In this example, a suitable mapping is obtained by translating target cell coordinates (I,J) to (I mod 7, J mod 7) and the mapping of 410 is not required.

At 412, the skip table is accessed to obtain cell indices for a cell as the table entry resolution and the intermediate resolution, along with a table exit cell identifier. At 413, sector origin coordinates are obtained at the table exit resolution from the target cell (I,J) using originI=I/7 and originJ=J/7, wherein “/” denotes integer division. At 414, it is determined if indices for additional resolutions are to be found and if so, at 422, coordinates (I,J) of the table exit cell are determined as I→originI+I mod 7 and J→originJ+Jmod 7. The new (I,J) coordinates are then used at 406 as above. If additional resolutions are not needed as determined at 414, an index of the table exit cell is determined at 416 and the determined indices for all resolutions evaluated can be output at 418.

For the aperture 7 example, division operation and modulus operations use the aperture 7; generally, these integer operations are performed using the aperture A as, for example, I/A and I mod A.

### Example 4. Application of a Two-Level Skip Table to a Select Target Cell in an Aperture 7 Hierarchy

The method 400 is illustrated with reference to FIGS. 5A-5E which illustrate a skip table sector 504 (FIG. 5B) defining a 2-level skip table 550 (FIG. 5C) which includes an auxiliary table 552 (FIG. 5D) for determination of skip table exit cell coordinates to produce an index 570 (FIG. 5E). A representative target cell 502 at resolution N having I=13, J=12 is selected as corresponding to a particular latitude and longitude as determined at 402 in FIG. 4. The method is operational to determine indices associated with the target cell in a fine resolution grid 510 and a cell 512 of an intermediate resolution grid 514 and I,J coordinates of a cell 514 of a coarse grid 516. In this example, the target cell 502 is associated with a skip table entry orientation, i.e., is part of a grid that is oriented as required by the skip table 550 defined with respect to a skip table sector 504. The target cell 502 is located in a grid sector 503 having a center cell 520 that is offset from a center cell 522 of the skip table grid sector 504 by ΔI=7 and ΔJ=7 along coordinate axes 590.

As shown in FIG. 4, at 406, the target cell 502 is translated to (I mod 7,J mod 7) to map the target cell to the skip table as (6,5). However, the cell (6,5) does not correspond to the target cell 502 as translated in the skip table sector, but in view of the skip table arrangement, the mapping produces the correct indices. The translated coordinates (6,5) are then mapped to correspond to the arrangement of the skip table 550 by adding 7 to both I and J. However, in some cases, the skip table 550 is prepared so that the appropriate cell indices can be retrieved using the translated (I,J) directly.

However, in this example, the skip table 550 is arranged so that a cell 514 having coordinates (−7,−7) in the skip table grid sector 512 is mapped to coordinates I=0, J=0 in the skip table 550. This mapping is for convenient coding and other mappings of the skip table grid sector 512 can be used to provide different skip tables, generally with the same values as in the skip table 550 but different skip table coordinates. Thus, in this example, the translated coordinates (6,5) are mapped to the skip table 450 as Iₛₜ=I+7 and Jₛₜ=J+7 to obtain (13,12), wherein Iₛₜ, Jₛₜ are coordinates mapped to the skip table 550.

With the target cell coordinates suitably translated and referring to the skip table 550 (the skip table mapped to cells is shown in FIG. 5CC), the coordinates (6,5) are associated with a skip table value (0x1, 016, 6), wherein 0x1 is not used and “016” in which “0” indicates that the following digits “1” and “6” are in octal, “1” is the index of the intermediate cell at resolution N−1 and “6” is the index of the table entry cell at resolution N. The results need not be expressed in octal, but this can be convenient. If the table exit resolution is the coarsest resolution or the coarsest resolution of interest as determined at 414, an index of the associated table exit resolution cell is determined at 416 and the indices are output at 418.

In this example, skip table 550 has entries of the form (A, B, C) in which indices of the table entry cell and the intermediate cell are found in the digits of B in FIG. 5C. If table exit resolution is not the desired final resolution as determined at 414, coordinates of the table exit cell are determined at 420. The coordinates of the skip table exit cell at resolution N−2 which is to be used as a table entry cell to find indices of additional cells at coarser resolutions can be determined from C which indicates which one of eight sets of cells labeled 0-8 as shown in FIG. 5F is associated with the associated N−2 resolution cell. In this example, C=6 is associated with coordinates (I_{C},J_{C})=(1,1) as shown in an auxiliary skip table 552 shown in FIG. 5C. These coordinates are with respect to the skip table sector 512 associated with the skip table 550. Updated initial coordinates (I′,J′) for the entry cell at the coarser resolution (in this example, the N−2 resolution) are found as follows:

$$I ’ = I / 7 + {I}_{C} and J ’ = J / 7 + {J}_{C} ,$$

wherein “/” denotes integer division, so in this example I′=13/7+I_{C}=1+1=2 and J′=12/7+J_{C}=1+1=2. The coordinates (I′,J′)=(2,2) can then be used with the skip table 550 to find indices of cells at a resolutions N−2, N−3 and determine coordinates of an associated cell at resolution N−4. This process can be continued until all indices of interest are obtained or a coarsest resolution is reached. FIG. 5E illustrates indices for the target cell resolution and an intermediate resolution.

### Cell Index Determination with Skip Tables for Arbitrary Resolutions

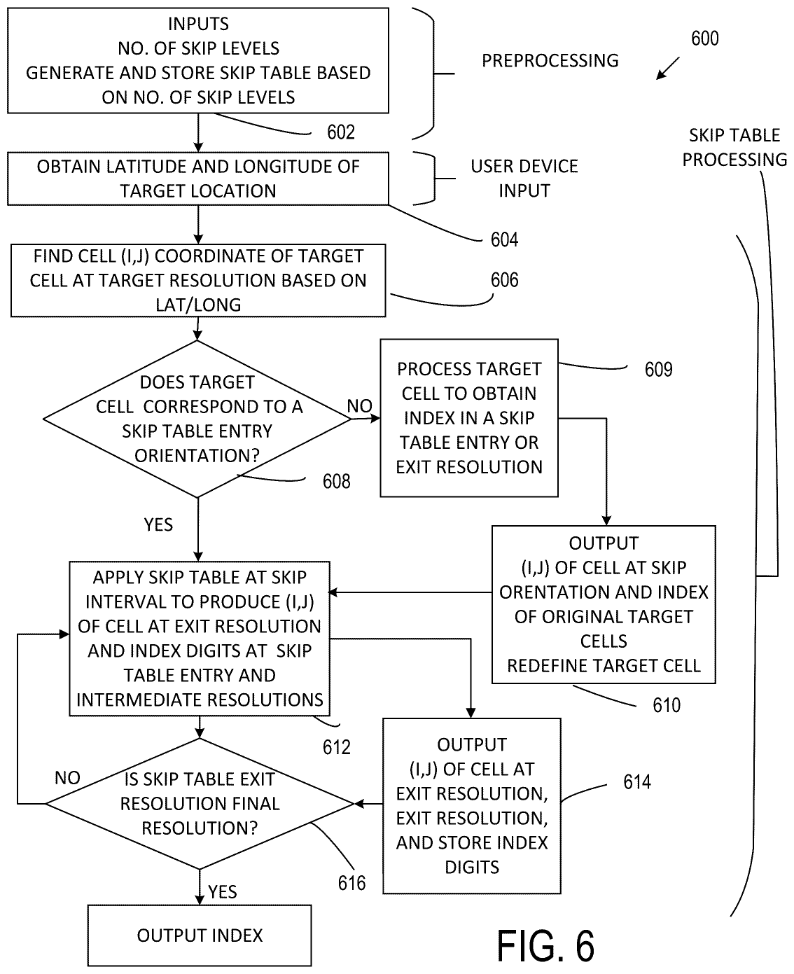

Referring to FIG. 6, a representative method 600 of determining cell indices and an address in a hierarchical grid system includes establishing a number of skip levels and generating and storing an associated skip table in one or more non-transitory processor-readable media at 602. The skip table is based on particulars of an associated hierarchical grid system and is generally operable to permit skipping over direct calculation of cell indices for cells at grid resolution between resolutions having a common alignment. The common alignment associated with an input cell and an exit resolution is referred to as a skip table orientation. Skip tables also depend on selection of a skip table sector which, as noted above, is of a shape that can tile a surface to which the hierarchical grid is mapped and includes at least A² cells, wherein A is the hierarchical grid aperture. In the example above for aperture A=7, a skip table sector based on a 2A-by-2A array of cells is used. Skip tables include entries corresponding to cells at an input resolution and at one or more intermediate resolutions as well as coordinates for a cell at an exit resolution. As indicated in FIG. 6, the establishing the skip table at 602 is generally done as preprocessing steps and the skip table stored in anticipation of applications as the skip table can be applied repeatedly as needed and need only be recalculated if a skip level orientation or associated hierarchical grid system is changed.

At 604, a latitude and longitude or other indication of a target location is determined. As indicated in FIG. 6, the target location can be provided by a user or a user device such as a smart phone that includes GPS processing. At 606, cell (I,J) coordinates for a cell (a target cell) at the target location are determined, typically a cell associated with a highest resolution of interest. At 608, it is determined if the identified target cell has an orientation corresponding to the skip table orientation. If not, the target cell is processed at 609 to find a cell index associated with the target cell and coordinates for a cell at the next coarser resolution. For the aperture 7 example, cell orientation alternates between resolutions, and determination of a single cell at a next coarser resolution can always provide a cell orientated properly for application of a skip table. For other hierarchical grids, cells at one, two or more coarser resolutions can be found to provide a cell oriented suitably for processing with the skip table. In some cases, skip tables having different skip table orientations can be provided, so that any target cell is suitably aligned for an available skip table. At 610, coordinates (I,J) of a cell at the skip table orientation based on the original target cell (a reoriented target cell having a coarser resolution than the target cell) are output along with an index of the original target cell. At 612, the skip table is applied to the reoriented target cell to produce indices for the reorientated target cell and one or more cells at successively coarser resolutions. The indices of the reoriented target cell and the one or more cells at the successively coarser resolutions and the coordinates of a cell having a next coarser resolution (the skip table exit resolution) are output at 614. At 616, it is determined if the resolution of the cell having the (I,J) coordinates has a selected coarsest resolution or coarsest desired resolution (referred to also as a “final” resolution). If not, processing returns to 612 for reapplication of the skip table at 612, with the processing continuing until an index associated with a selected coarsest resolution is obtained.

If a target cell is determined to have an orientation correspond to the skip table orientation, then the skip table can be applied using the target cell coordinates at 612 without finding an associated intermediate cell at a coarser resolution to use for skip table processing as done at 609, 610. Once a desired coarsest resolution is obtained, a target cell address is output corresponding to the indices of the target cell and the cells identified by skip table processing. In some cases, an orientation of a cell produced by skip table processing has an orientation different than that of cells of a desired coarsest grid, and processing such as performed at 609-610 must be carried out, but in this case, applied to determine a cell index for a coarser cell that does not have the skip table orientation instead of a coarser cell having the skip table orientation.

### Computing Environment

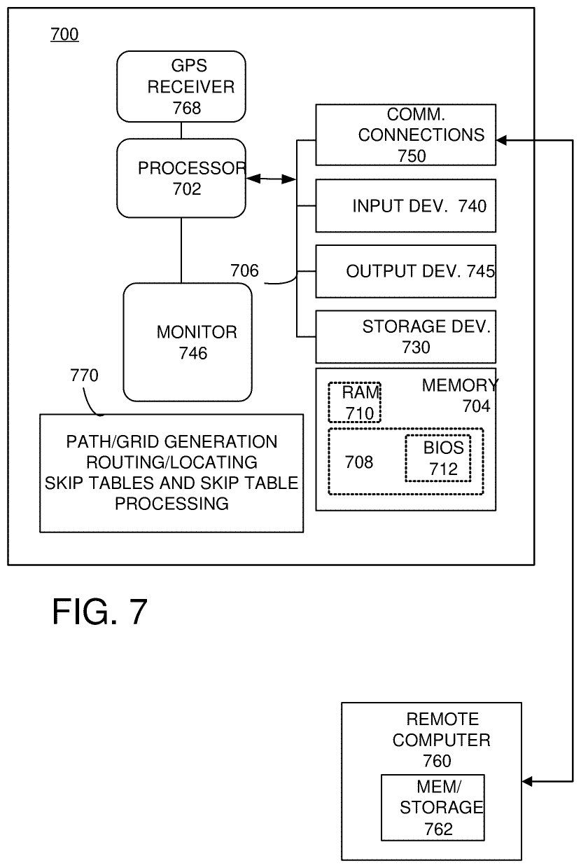

FIG. 7 and the following discussion are intended to provide a brief, general description of an exemplary computing environment in which the disclosed technology may be implemented. Such technology or portions thereof are generally including in positioning and navigation systems, spatial database systems, spatial machine learning/AI systems, as well as other systems using location-based data. Although not required, the disclosed technology is described in the general context of computer executable instructions, such as program modules, being executed by one or more processors. Generally, program modules include routines, programs, objects, components, data structures, etc., that perform particular tasks or implement particular abstract data types. Moreover, the disclosed technology may be implemented with other computer system configurations, including handheld devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 7, an exemplary system for implementing the disclosed technology includes a general purpose computing device in the form of an exemplary conventional PC 700, including one or more processing units 702, a system memory 704, and a system bus 706 that couples various system components including the system memory 704 to the one or more processing units 702. The system bus 706 may be any of several types of bus structures including a memory bus or memory controller, a peripheral bus, and a local bus using any of a variety of bus architectures. The exemplary system memory 704 includes read only memory (ROM) 708 and random-access memory (RAM) 710. A basic input/output system (BIOS) 712, containing the basic routines that help with the transfer of information between elements within the PC 700, is stored in ROM 708.

The exemplary PC 700 further includes one or more storage devices 730 such as a hard disk drive for reading from and writing to a hard disk, a magnetic disk drive for reading from or writing to a removable magnetic disk, and an optical disk drive for reading from or writing to a removable optical disk (such as a CD-ROM or other optical media). Such storage devices can be connected to the system bus 706 by a hard disk drive interface, a magnetic disk drive interface, and an optical drive interface, respectively. The drives and their associated computer readable media provide nonvolatile storage of computer-readable instructions, data structures, program modules, and other data for the PC 700. Other types of computer-readable media which can store data that is accessible by a PC, such as magnetic cassettes, flash memory cards, digital video disks, CDs, DVDs, RAMs, ROMs, and the like, may also be used in the exemplary operating environment.

A number of program modules may be stored in the storage devices 730 including an operating system, one or more application programs, other program modules, and program data. A user may enter commands and information into the PC 700 through one or more input devices 740 such as a keyboard and a pointing device such as a mouse. Other input devices may include a digital camera, microphone, joystick, game pad, satellite dish, scanner, or the like. These and other input devices are often connected to the one or more processing units 702 through a serial port interface that is coupled to the system bus 706 but may be connected by other interfaces such as a parallel port, game port, or universal serial bus (USB). A monitor 746 or other type of display device is also connected to the system bus 706 via an interface, such as a video adapter. Other peripheral output devices, such as speakers and printers (not shown), may be included.

The PC 700 may operate in a networked environment using logical connections to one or more remote computers, such as a remote computer 760. In some examples, one or more network or communication connections 750 are included. The remote computer 760 may be another PC, a server, a router, a network PC, or a peer device or other common network node, and typically includes many or all of the elements described above relative to the PC 700, although only a memory storage device 762 has been illustrated in FIG. 7. The personal computer 700 and/or the remote computer 760 can be connected to a logical a local area network (LAN) and a wide area network (WAN). Such networking environments are commonplace in offices, enterprise-wide computer networks, intranets, and the Internet.

When used in a LAN networking environment, the PC 700 is connected to the LAN through a network interface. When used in a WAN networking environment, the PC 700 typically includes a modem or other means for establishing communications over the WAN, such as the Internet. In a networked environment, program modules depicted relative to the personal computer 700, or portions thereof, may be stored in the remote memory storage device or other locations on the LAN or WAN. The network connections shown are exemplary, and other means of establishing a communications link between the computers may be used.

Computer-executable instructions for generating grids, assigning locations, obtaining distances, and skip table processing can be stored in non-transitory memory 770 or stored remotely. Typically, a GPS receiver 768 is coupled to the processor, but can be situated remotely as well.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), etc. Such components may be especially useful for low cost, mobile devices, or for real-time applications such as the navigation system of an autonomous vehicle. Such a component might be integrated directly on or with a GPS system or similar location determination hardware components to form an integrated location sub-system.

### Representative Navigation System

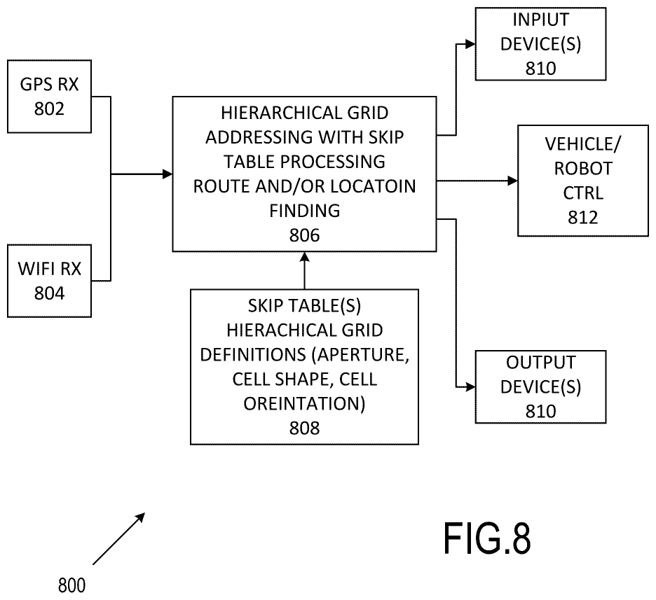

Referring to FIG. 8, a representative system 800 includes a GPS receiver 8023 and a WiFi receiver 804 that are coupled to a processor 806. The processor 806 is operable to perform hierarchical grid addressing for route or location finding using skip tables retrievable from one or more non-transitory processor readable media 808. The processor 806 can determine location and an associated target cell to obtain a suitable hierarchical address. The processor 806 is coupled to one or more output devices 810 to inform a user or input devices 812 associated with other systems that require hierarchical addresses such as for calculation of routes or locations. In addition, the processor 806 can communicate hierarchical addresses to a vehicle or robot 814 for control or guidance of the vehicle or robot.

### Representative Inverse Skip Table Processing

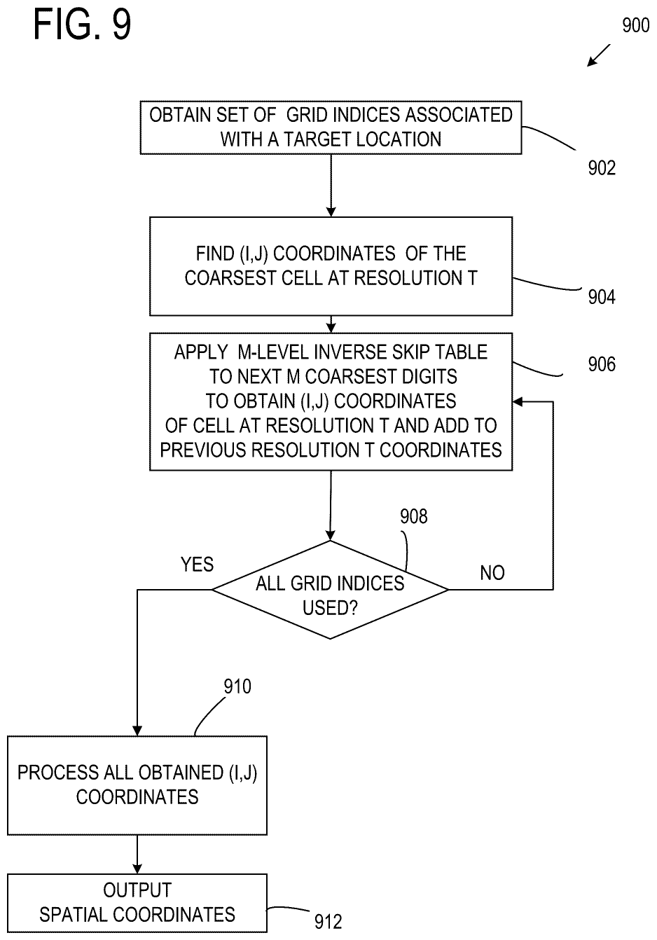

The examples above describe use of a skip table that permits processing of a target location defined by spatial coordinates such as latitude and longitude to determine indices in a hierarchical grid. This approach can be reversed to begin with a set of grid indices associated with a target location and processing the set to obtain spatial coordinates of a target location using a skip table, referred to for convenience as an “inverse” skip table. Skip tables are constructed to process sets of grid indices with a maximum resolution R by choosing a fixed target grid resolution T, where T is greater-than-or-equal-to R. Referring to FIG. 9, a representative method 900 includes obtaining a set of grid indices associated with a target location at 902. At 904, the (I,J) coordinates of a coarsest cell defined by the set is obtained for resolution T.

At 906, an M-level inverse skip table is applied to the next coarsest M digits to obtain the corresponding (I,J) coordinates of a cell at resolution T, and these resolution T (I,J) coordinates are added to the previously determined resolution T coordinates. At 908, it is determined if all indices of the set have been processed, and if so, the final resolution T coordinates (I,J) resulting from taking the running total of previous applications of the M-level inverse skip table are processed at 910 to obtain spatial coordinates of the target location such as latitude and longitude. At 912, the spatial location is output as, for example, latitude and longitude. If all grid indices have not been used as determined at 908, processing returns to 906 and the subsequent steps are repeated as needed.

While inverse skip table processing is similar to the “forward” skip table processing discussed extensively above, there are some differences. For example, inverse skip tables do not need to correspond to specific grid orientations, as required forward skip tables. Excess resolutions before or after processing groups of M need not be trimmed. If there are digits beyond the cell resolution R, those should be set to an invalid digit value (e.g. aperture 7 has valid digits 0-6, and digit 7 indicates an unused digit), which can be accounted for in the inverse skip table. Then the entire index can be processed up to the target resolution T in groups of M digits, without caring what R is. Beyond resolution R each group will be M invalid digits, which will contribute (0,0) to the resolution T coordinates being determined.

M-digit inverse skip tables can be specific to a particular M resolutions as described here. So if M is 3 there would be a table for processing index digits 1-3, another for 4-6, etc. down to resolution T. These tables are actually the same table scaled for how far the resolutions of the M indices are from resolution T. Note that the value of M need not be the same for all of the inverse skip tables. For example, there could be an M=3 inverse skip table to process resolutions 1-3, and an M=4 inverse skip table to process resolutions 4-7, etc.

Alternately, a single M-digit table can be used and applied successively to groups of M digits from coarsest to finest. At each application of the inverse skip table the indicated (I,J) coordinates would then be scaled based on the resolution of the specific M index digits currently being processed before adding to the running-total resolution T coordinates. This trades-off smaller table sizes for more processing time.

For example, for H3 indexes with a fixed M=3 and T=16 (recall that the maximum H3 resolution is 15), the M=3 inverse skip tables process 3 index digits at a time, which can have values ranging from octal 000 to 777. The index digits are interpreted as an octal value indicating the skip table index. The following table down3tblRes1 gives the resolution T coordinates for the resolution 1-3 digits. The table is not complete for space reasons.

| const CoordIJ down3tblRes1[0777 + 1] = { | |
|---|---|
| {0, 0}, | // input 000 |
| {−235298, −352947}, | // input 001 |
| {−117649, 235298}, | // input 002 |
| {−352947, −117649}, | // input 003 |
| {352947, 117649}, | // input 004 |
| {117649, −235298}, | // input 005 |
| {235298, 352947}, | // input 006 |
| {0, 0}, | // input 007 |
| {−823543, −823543}, | // input 010 |
| ... | |
| {1176490, −1529437}, | // input 504 |
| {941192, −1882384}, | // input 505 |
| {1058841, −1294139}, | // input 506 |
| {823543, −1647086}, | // input 507 |
| {0, −2470629}, | // input 510 |
| {−235298, −2823576}, | // input 511 |
| {−117649, −2235331}, | // input 512 |
| ... | |
| {33614, 50421}, | // input 767 |
| {0, 0}, | // input 770 |
| {−16807, −16807}, | // input 771 |
| {0, 16807}, | // input 772 |
| {−16807, 0}, | // input 773 |
| {16807, 0}, | // input 774 |
| {0, −16807}, | // input 775 |
| {16807, 16807}, | // input 776 |
| {0, 0}, | // input 777 |
| } | |

### Representative Logistics Management System

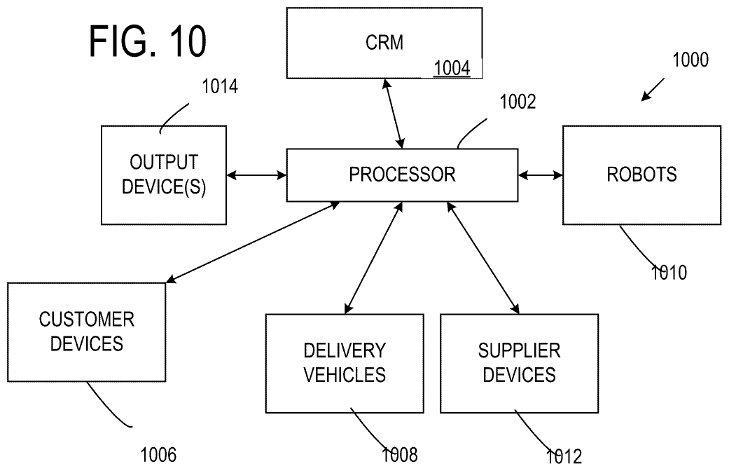

Referring to FIG. 10, an exemplary system 1000 includes a processor 1002 that is operable to perform hierarchical grid addressing for tracking and managing customers, product orders, and delivery vehicles using skip tables retrievable from one or more non-transitory processor-readable media 1004. The processor 1002 receives updated locations and delivery status updates from customer devices 1006, from delivery vehicles 1008 or robots 1010, and supplier devices 1012. Devices used by customers, suppliers, delivery vehicles and others include stand alone or built-in GPS devices, smartphones, laptops, desktops, and other processor devices. The processor 1002 is configured to determine associated target cells to obtain suitable hierarchical addresses and can be coupled to one or more output devices 1014. The processor 1002 is coupled to one or more output devices 1014 to inform users or input devices associated with other systems that require hierarchical addresses, such as those that optimize and schedule delivery routes based on the locations indicated by the hierarchical addresses using calculations and/or Artificial Intelligence processing. In addition, the processor 1002 can communicate hierarchical addresses to delivery vehicles 1008 or robots 1010 for control or guidance of the vehicles or robots, or to communicate updated delivery status information to customers.

Drone deliveries, sub-space debris mapping and satellite applications, autonomous vehicles, and other applications can incorporate the disclosed approaches. Other industrial, scientific or military applications not specifically described herein in can also be improved by the performance advantages using the disclosed methods and apparatus.

### Representative Disclosure Paragraphs

Paragraph 1 is a method of determining an address of a location in a hierarchical grid system, including, with a processor: identifying a target cell associated with a selected location in a hierarchical grid system; and applying a skip table to determine cell indices for at least a first cell and a second cell associated with the target cell at successively coarser resolutions.

Paragraph 2 includes the subject matter of Paragraph 1, and further specifies that the successively coarser resolutions are resolutions coarser than a resolution of the target cell.

Paragraph 3 includes the subject matter of any of Paragraphs 1-2, and further specifies that the successively coarser resolutions include a resolution of the target cell and a successively coarser resolution than that of the target cell and the cell indices include an index of the target cell.

Paragraph 4 includes the subject matter of any of Paragraphs 1-3, and further specifies that the skip table is an M-level skip table, wherein M is an integer greater than one, and the M-level skip table is applied to determine cell indices for at least M cells at M successively coarser resolutions.

Paragraph 5 includes the subject matter of any of Paragraphs 1-4, and further specifies that the at least M cells at M successively coarser resolutions are cells at resolutions coarser than a resolution of the target cell.

Paragraph 6 includes the subject matter of any of Paragraphs 1-5, and further specifies that the at least M cells at M successively coarser resolutions include a cell at the resolution of the target cell and the cell indices include an index of the target cell.

Paragraph 7 includes the subject matter of any of Paragraphs 1-6, and further specifies that the M-level skip table is applied to determine coordinates of a cell associated with the target cell at a resolution that is successively coarser than the coarsest resolution of the at least M cells.

Paragraph 8 includes the subject matter of any of Paragraphs 7, and further includes finding at least one route to or from a location associated with the target cell based on the at least M cells.

Paragraph 9 includes the subject matter of any of Paragraphs 1-8, and further specifies that the at least one route is a shortest route or a route with a shortest travel time.

Paragraph 10 includes the subject matter of any of Paragraphs 1-9, and further specifies that the skip table has a skip table orientation, and further wherein, for a target cell having the skip table orientation the at least M cells at M successive coarser resolutions than the resolution of the target cell.

Paragraph 11 includes the subject matter of any of Paragraphs 1-10, and further includes finding an index associated with a cell at a resolution coarser than that of the at least M cells and having a cell orientation different from a skip table orientation.

Paragraph 12 includes the subject matter of any of Paragraphs 1-11, and further specifies that the hierarchical grid is an aperture 7 hexagonal hierarchical grid or an aperture 3 hexagonal hierarchical grid or a hexagonal hierarchical grid with a mixture of one or more of aperture 3, aperture 4, and aperture Paragraph 7.

Paragraph 13 includes the subject matter of any of Paragraphs 1-12, and further specifies that the skip table includes cell indices associated with cells of a skip table sector.

Paragraph 14 includes the subject matter of any of Paragraphs 1-13, and further includes receiving location data and identifying the target cell based on the location data.

Paragraph 15 is a navigation apparatus, including: at least one logical processor; and at least one processor readable storage medium storing processor-executable instructions to determine a hierarchical address of a target cell using a skip table.

Paragraph 16 includes the subject matter of Paragraph 15, and further specifies that the processor-executable instructions to determine the hierarchical address of a target cell using the skip table are based on integer arithmetic.

Paragraph 17 includes the subject matter of any of Paragraphs 15-16, and further specifies that the processor-executable instructions further comprise processor-executable instructions operable to identify the target cell based on a latitude and longitude.

Paragraph 18 includes the subject matter of any of Paragraphs 15-16, and further specifies that the processor-executable instructions are operable to determine cell indices for at least a first cell and a second cell associated with the target cell at successively coarser resolutions based on application of the skip table.

Paragraph 19 includes the subject matter of any of Paragraphs 15-18, and further specifies that the successively coarser resolutions include a resolution of the target cell and a successively coarser resolution than that of the target cell and the cell indices include an index of the target cell.

Paragraph 20 includes the subject matter of any of Paragraphs 15-19, and further specifies that: the skip table is an M-level skip table, wherein M is an integer greater than one; the M-level skip table is applied to determine cell indices for at least M cells at M successively coarser resolutions, wherein the cells at M successively coarser resolutions are cells at resolutions coarser than a resolution of the target cell or the cells at M successively coarser resolutions include the target cell; and the M-level skip table is applied to determine cell coordinates for at least one cell at a next coarser resolution than the M cells.

Paragraph 21 is a method of determining cell indices in a hierarchical grid system having resolutions associated with cells at a common orientation at regular intervals using a processor, including, with the processor: obtaining an M-level skip table associated with a skip table entry resolution, wherein M is an integer greater than 1; and applying the M-level skip table to a cell in the grid system at a first resolution to obtain a cell index for the cell at the first resolution and M−1 cell indices for M−1 cells in the grid system at successive resolutions coarser than the first resolution, coarser that the first resolution

Paragraph 22 includes the subject matter of Paragraph 21, and further specifies that applying the skip table to the cell at the first resolutions produces coordinates of a corresponding cell at a resolution M.

Paragraph 23 includes the subject matter of Paragraphs 21-22, repetitively applying the skip table to cells having coordinates produced with the skip at successively coarser skip table output resolutions to obtain a cell index for the cell at the respective skip table output resolution and M−1 cell indices for M−1 cells in the grid system at the successively coarser resolutions

Paragraph 24 is a method of determining a target location based on a set of cell indices in a hierarchical grid, including, with a processor: obtaining an M-level inverse skip table, wherein M is an integer greater than 1; successively applying the M-level inverse skip table to cells associated with grid indices of respective finer cells in the grid system; and obtaining a target spatial location based on coordinates of a cell associated with the finest resolution.

In view of the many possible embodiments to which the principles of the disclosed technology may be applied, it should be recognized that the illustrated embodiments are only preferred examples and should not be taken as limiting the scope of the disclosure.

I claim:

1. A method of determining an address of a location in a hierarchical grid system, comprising, with a processor:
identifying a target cell associated with a selected location in a hierarchical grid system; and
applying a skip table to determine cell indices for at least a first cell and a second cell associated with the target cell at successively coarser resolutions.

2. The method of claim 1, wherein the successively coarser resolutions are resolutions coarser than a resolution of the target cell.

3. The method of claim 1, wherein the successively coarser resolutions include a resolution of the target cell and a successively coarser resolution than that of the target cell and the cell indices include an index of the target cell.

4. The method of claim 1, wherein the skip table is an M-level skip table, wherein M is an integer greater than one, and the M-level skip table is applied to determine cell indices for at least M cells at M successively coarser resolutions.

5. The method of claim 4, wherein the at least M cells at M successively coarser resolutions are cells at resolutions coarser than a resolution of the target cell.

6. The method of claim 4, wherein the at least M cells at M successively coarser resolutions include a cell at the resolution of the target cell and the cell indices include an index of the target cell.

7. The method of claim 4, wherein the M-level skip table is applied to determine coordinates of a cell associated with the target cell at a resolution that is successively coarser than the coarsest resolution of the at least M cells.

8. The method of claim 7, further comprising finding at least one route to or from a location associated with the target cell based on the at least M cells.

9. The method of claim 8, wherein the at least one route is a shortest route or a route with a shortest travel time.

10. The method of claim 4, wherein the skip table has a skip table orientation, and further wherein, for a target cell having the skip table orientation the at least M cells at M successive coarser resolutions than the resolution of the target cell.

11. The method of claim 4, further comprising finding an index associated with a cell at a resolution coarser than that of the at least M cells and having a cell orientation different from a skip table orientation.

12. The method of claim 1, wherein the hierarchical grid is an aperture 7 hexagonal hierarchical grid or an aperture 3 hexagonal hierarchical grid or a hexagonal hierarchical grid with a mixture of one or more of aperture 3, aperture 4, and aperture 7.

13. The method of claim 1, wherein the skip table includes cell indices associated with cells of a skip table sector.

14. The method of claim 1, further comprising receiving location data and identifying the target cell based on the location data.

15. A navigation apparatus, comprising:
at least one logical processor; and
at least one processor readable storage medium storing processor-executable instructions to determine a hierarchical address of a target cell using a skip table.

16. The navigation apparatus of claim 15, wherein the processor-executable instructions to determine the hierarchical address of a target cell using the skip table are based on integer arithmetic.

17. The navigation apparatus of claim 15, wherein the processor-executable instructions further comprise processor-executable instructions operable to identify the target cell based on a latitude and longitude.

18. The navigation apparatus of claim 15, wherein the processor-executable instructions are operable to determine cell indices for at least a first cell and a second cell associated with the target cell at successively coarser resolutions based on application of the skip table.

19. The navigation apparatus of claim 18, wherein the successively coarser resolutions include a resolution of the target cell and a successively coarser resolution than that of the target cell and the cell indices include an index of the target cell.

20. The navigation apparatus of claim 15, wherein:
the skip table is an M-level skip table, wherein M is an integer greater than one;
the M-level skip table is applied to determine cell indices for at least M cells at M successively coarser resolutions, wherein the cells at M successively coarser resolutions are cells at resolutions coarser than a resolution of the target cell or the cells at M successively coarser resolutions include the target cell; and
the M-level skip table is applied to determine cell coordinates for at least one cell at a next coarser resolution than the M cells.

21. A method of determining cell indices in a hierarchical grid system having resolutions associated with cells at a common orientation at regular intervals, comprising, with a processor:
obtaining an M-level skip table associated with a skip table entry resolution, wherein M is an integer greater than 1; and
applying the M-level skip table to a cell in the grid system at a first resolution to obtain a cell index for the cell at the first resolution and M−1 cell indices for M−1 cells in the grid system at successive resolutions coarser than the first resolution, coarser that the first resolution.

22. The method of claim 21, wherein applying the skip table to the cell at the first resolutions produces coordinates of a corresponding cell at a resolution M.

23. The method of claim 22, repetitively applying the skip table to cells having coordinates produced with the skip at successively coarser skip table output resolutions to obtain a cell index for the cell at the respective skip table output resolution and M−1 cell indices for M−1 cells in the grid system at the successively coarser resolutions.

24. A method of determining a target location based on a set of cell indices in a hierarchical grid system, comprising, with a processor:
determining cell coordinates of a coarsest cell associated with a target location;
obtaining an M-level inverse skip table, wherein M is an integer greater than 1;
successively applying the M-level inverse skip table to find coordinates of M finer cells in the hierarchical grid system; and
obtaining a target spatial location based on coordinates of a cell associated with a finest resolution.
